(19) United States
(12) Patent Application Publication
(10) Pub. No.: US 2026/0183730 A1
(43) Pub. Date: Jul. 2, 2026

(54) PARTICULATE SOLID DISTRIBUTORS SUITABLE FOR DISTRIBUTING MULTIPLE PARTICULATE SOLID STREAMS

(71) Applicant: Dow Global Technologies LLC, Midland, MI (US)

(72) Inventors: Lin Luo, Sugarland, TX (US); Hangyao Wang, Pearland, TX (US); Matthew T. Pretz, Lake Jackson, TX (US); Quan Yuan, Sugarland, TX (US); Liwei Li, Houston, TX (US)

(73) Assignee: Dow Global Technologies LLC, Midland, MI (US)

(21) Appl. No.: 19/131,638

(22) PCT Filed: Nov. 27, 2023
(86) PCT No.: PCT/US2023/081076

§ 371 Date: May 21, 2025

Related U.S. Application Data
(60) Provisional application No. 63/428,524, filed on Nov. 29, 2022.

(51) Int. Cl. B01J 8/00

(52) U.S. Cl. CPC B01J 8/0015; B01J 2208/00752; B01J 2208/00938

(57) ABSTRACT

A particulate solids distributor suitable for distributing two particulate solid streams may include an inner conduit extending from an inner conduit inlet to an inner conduit outlet. The inner conduit may be defined at least partially by an inner wall and the inner wall may be arranged around a central axis. The particulate solids distributor may also include an outer conduit defined at least partially by the inner wall and an outer wall. The outer conduit may extend from an outer conduit inlet to an outer conduit outlet. The outer wall may be arranged around the central axis and a crosssection of the outer wall may surround a crosssection of the inner wall in a plane perpendicular to the central axis. The particulate solids distributor may also include a first solids director positioned over the central axis and downstream of the inner conduit outlet. The particulate solids distributor may also include a second solids director attached to the inner wall and extending radially outward from the central axis. The inner conduit may extend past the outer conduit such that the inner conduit outlet may be downstream of the outer conduit outlet.

### CROSS-REFERENCE TO RELATED APPLICATIONS

This application claims the benefit of U.S. Provisional Application Ser. No. 63/428,524 filed Nov. 29, 2022, the entire disclosure of which is hereby incorporated herein by reference.

### TECHNICAL FIELD

Embodiments described herein generally relate to distributors and, more specifically, to distributors suitable for distributing particulate solids streams.

### BACKGROUND

Particulate solids may be utilized in a variety of ways in chemical processes. For example, particulate solids may be utilized as catalysts for chemical processes such as fluidized bed reactions. As the requirements for various chemical processes can differ greatly chemical processes may benefit from introducing the particulate solid in a specific manner. Thus, there is an industry demand for particulate solid distributors that can distribute particulate solid to match process needs.

### SUMMARY

Chemical processes may utilize particulate solids and, in some circumstances, multiple, separate particulate solids streams that are injected into the same reactor or other vessel. Described herein are particulate solid distributors suitable for use in distributing two separate particulate solid streams into different portions of a reactor or other process unit. For example, some embodiments described herein may be suitable for passing two different particulate solid streams at different heights. Such distributors may be operable for passing solids, such as catalysts, into fluidized bed reactors and the like wherein, in some embodiments, such a catalyst stream pattern may be beneficial. The distributors described herein may be capable of introducing multiple particulate solids streams at different heights, but with both streams emanating from the near or at the center of the reactor or other process vessel.

According to one or more embodiments described herein a particulate solids distributor suitable for distributing two particulate solid streams may comprise an inner conduit extending from an inner conduit inlet to an inner conduit outlet. The inner conduit may be defined at least partially by an inner wall and the inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis and a cross-section of the outer wall may surround a cross-section of the inner wall in a plane perpendicular to the central axis. The particulate solids distributor may also comprise a first solids director positioned over the central axis and downstream of the inner conduit outlet. The particulate solids distributor may also comprise a second solids director attached to the inner wall and extending radially outward from the central axis. The inner conduit may extend past the outer conduit such that the inner conduit outlet may be downstream of the outer conduit outlet.

According to one or more embodiments a particulate solids distributor suitable for distributing two particulate solid streams may comprise an inner conduit extending from an inner conduit inlet to an inner conduit outlet. The inner conduit may be defined at least partially by an inner wall, and the inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis. A cross-section of the outer wall may surround a cross-section of the inner wall in a plane perpendicular to the central axis. The particulate solids distributor may also comprise an inlet conduit defined at least partially by an inlet conduit wall. The inlet conduit may extend from an inlet conduit inlet to an inlet conduit outlet. The inlet conduit may intersect the outer wall. The inlet conduit outlet may be positioned at the inner wall such that the inlet conduit may be in communication with the inner conduit. The particulate solids distributor may also comprise a first solids director positioned over the central axis and downstream of the inner conduit outlet. The particulate solids distributor may also comprise a second solids director attached to the inner wall and extending radially outward from the central axis. The inner conduit may extend past the outer conduit such that the inner conduit outlet may be downstream of the outer conduit outlet.

According to one or more embodiments a particulate solids distributor for distributing two particulate solids streams may comprise an inner conduit extending from an inner conduit inlet to an inner conduit outlet. The inner conduit may be defined at least partially by an inner wall. The inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis. A cross-section of the outer wall may surround a cross-section of the inner wall in a plane perpendicular to the central axis. The particulate solids distributor may also comprise an inlet conduit defined at least partially by an inlet conduit wall. The inlet conduit may extend from an inlet conduit inlet to an inlet conduit outlet. The inlet conduit outlet may be positioned at the outer wall such that the inlet conduit may be in communication with the outer conduit. The particulate solids distributor may also comprise a first solids director positioned over the central axis and downstream of the inner conduit outlet. The particulate solids director may also comprise a second solids director attached to the inner wall and extending radially outward from the central axis. The inner conduit may extend past the outer conduit such that the inner conduit outlet may be downstream of the outer conduit outlet.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a particulate solids distributor, according to one or more embodiments disclosed herein;

FIG. 2 schematically depicts another particulate solids distributor, according to one or more embodiments disclosed herein;

FIG. 3 schematically depicts a chemical processing vessel using the particulate solids distributor of FIG. 1, according to one or more embodiments disclosed herein; and

FIG. 4 schematically depicts a reactor system that may be used with embodiments of the present disclosure, according to one or more embodiments disclosed herein.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### DETAILED DESCRIPTION

Reference will now be made in detail to various embodiments of devices, assemblies, and methods, examples of which are illustrated in the accompanying drawings. Whenever possible, the same reference numerals will be used throughout the drawings to refer to the same or like parts.

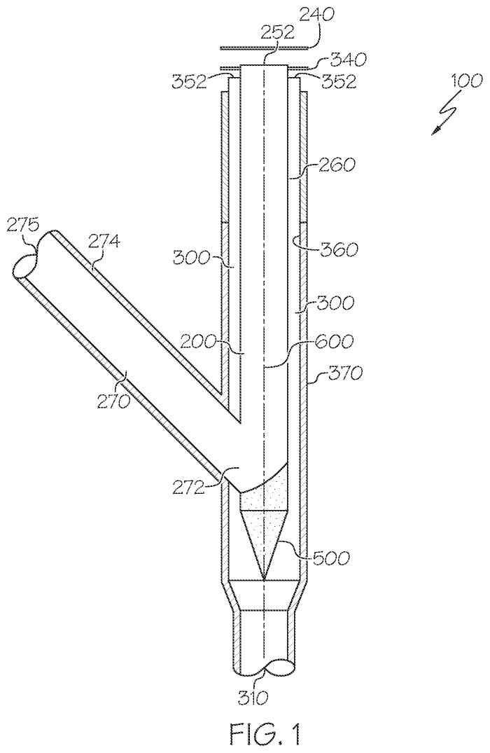

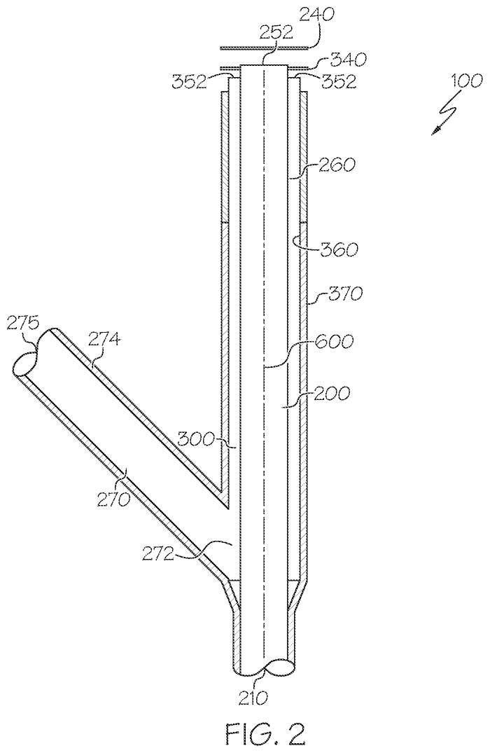

The present disclosure generally relates to particulate solid distributors and the operation of such distributors. Referring to FIGS. 1 and 2, perspective, schematic views of two particulate solids distributors 100 are depicted. Each of the embodiments of FIGS. 1 and 2, respectively include an inner conduit 200 and an outer conduit 300. Generally, the particulate solids distributors 100 of FIGS. 1 and 2 are similar in many respects, but include some differences, as described. In particular, the solids distributor of FIG. 1 includes an inlet conduit 270 that is in fluid communication with the inner conduit 200, whereas the embodiment of FIG. 2 includes an inlet conduit 270 that is in fluid communication with the outer conduit 300.

Still referring to FIGS. 1 and 2, the particulate solids distributor 100 may include an inner conduit 200 and an outer conduit 300. The inner conduit 200 may extend from an inner conduit inlet 210 to an inner conduit outlet 252. The inner conduit 200 may be at least partially defined by an inner wall 260. Generally, the inner conduit 200 may be bound by the inner wall 260, which may be, for example, a pipe shaped member. The inner wall 260 may be arranged around a central axis 600. The outer conduit 300 may extend from an outer conduit inlet 310 to an outer conduit outlet 352. The outer conduit 300 may be at least partially defined by the inner wall 260 and an outer wall 360, where the space between inner wall 260 and outer wall 360 may bound the outer conduit 300. The outer wall 360 may be arranged around the central axis 600 and a cross-section of the outer wall 360 may surround a cross-section of the inner wall 260 in a plane perpendicular to the central axis 600. As described herein, generally a first particulate solid stream may pass upwards through the inner conduit 200 and a second particulate solids stream may pass upwardly through the outer conduit 300.

In one or more embodiments, the inner wall 260 may have a circular, oval, elliptical, or polygonal cross-sectional shape in a plane perpendicular to the central axis 600. In one or more embodiments, the outer wall 360 may have a circular, oval, elliptical, or polygonal cross-sectional shape in a plane perpendicular to the central axis 600. In some embodiments, the inner wall 260 and the outer wall 360 may both have a circular cross-sectional shape in a plane perpendicular to the central axis 600 as depicted in FIGS. 1 and 2. In one or more embodiments, inner wall 260 and the outer wall 360 may have the same cross-sectional shape in a plane perpendicular to the central axis 600. In other embodiments, the inner wall 260 and the outer wall 360 may have different cross-sectional shapes in a plane perpendicular to the central axis 600. In some embodiments, as depicted in FIGS. 1 and 2, the outer wall 360 may have a refractory lining 370. In some embodiments, (not shown in FIGS. 1 and 2) the outer wall 360 may not have a refractory lining 370.

As described with respect to FIGS. 1 and 2, the inner conduit 200 and outer conduit 300 may form a co-axial arrangement. In such embodiments, the inner conduit 200 may be surrounded by the outer conduit 300 in the direction perpendicular to the central axis 600.

In one or more embodiments, the inner conduit 200 extends past the outer conduit 300. In such embodiments, the inner conduit outlet 252 may be downstream of the outer conduit outlet 352. For example, as depicted in FIGS. 1 and 2, the inner wall 260 (defining the inner conduit 200) extends upwardly past the end point of the outer wall 360 (defining the outer conduit outlet 352 of the outer conduit 300). As used in the present disclosure, the term “downstream” refers to the position along a conduit more near the outlet than the inlet, generally in the direction of particulate solid flow. As used in the present disclosure the term “upstream” refers to the positions along a conduit more near the inlet than the outlet, generally in the opposite direction of particulate solid flow.

As described herein, generally a first particulate solids stream may pass out of the inner conduit 200 through the inner conduit outlet 252 above a second particulate solid stream that may pass out of the outer conduit 300 through the outer conduit outlet 352. In some embodiments, the portion of the inner wall 260 that extends upwardly past the end point of the outer wall 360 (defining the outer conduit outlet 352 of the outer conduit 300) may have a refractory lining on the side of the inner wall 260 facing opposite of the inner conduit 200.

The particulate solids distributor 100 may include a first solids director 240 and a second solids director 340. The first solids director may be positioned over the central axis 600 and downstream of the inner conduit outlet 252, such that a particulate solid may flow from the inner conduit inlet 210 to the inner conduit outlet 252 and be directed by the first solids director 240 out of the particulate solids distributor. In one or more embodiments, as shown in FIGS. 1 and 2 the first solids director 240 may be a first deflector plate. Generally, as described herein, the first particulate solid stream may pass out of the inner conduit outlet 252 and contact the first deflector plate. The first particulate solid stream may then be deflected by the first deflector plate radially outward from the particulate solids distributor 100. The first solids director 240 may be supported by a variety of means, such as attachments to the inner wall 260 or the like (not depicted in the figures).

In one or more embodiments, the second solids director 340 may be attached to the inner wall 260 and extend radially outward from the central axis 600. In one or more embodiments, the second solids director 340 may be positioned on a portion of the inner wall 260 extending past the outer wall 360. In some embodiments, as shown in FIGS. 1 and 2 the second solids director 340 and the inner wall 260 may form a co-axial arrangement. In such embodiments, a portion of the inner wall 260 may be surrounded by the second solids director 340. In some embodiments, the inner wall 260 may extend past the second solids director 340. For example, as shown in FIGS. 1 and 2, a portion of the inner wall 260 extends upwardly past the second solids director 340. In some embodiments, not shown in FIGS. 1 and 2, the inner wall 260 may not extend past the second solids director 340. In such embodiments, the portion of the inner wall 260 defining the inner conduit outlet 252 of the inner conduit 200 may be level with a surface of the second solids director 340. In one or more embodiments, as shown in FIGS. 1 and 2 the second solids director 340 may be a second deflector plate. Generally, as described herein, the second particulate solid stream may pass out of the outer conduit outlet 352 and contact the second deflector plate 340. The second particulate solid stream may then be deflected by the second deflector plate radially outward from the particulate solids distributor 100.

In one or more embodiments, where the first solids director 240 is circularly shaped, the area of a cylinder having a radius equal to a radius of the first solids director 240 and having a height equal to distance between the first solids director 240 and the inner conduit outlet 252 may be from 125 % to 175% of the area of the cross-section of the inner wall 260. For example, the area of the cylinder may be from 125% to 170% the area of the cross-section of the inner conduit outlet 252, such as from 125% to 165%, from 125% to 160%, from 125% to 155%, from 125% to 150%, from 125% to 145%, from 125% to 140%, from 125% to 135%, from 125% to 130%, from 130% to 175%, from 130% to 170%, from 130% to 165%, from 130% to 160%, from 130% to 155%, from 130% to 145%, from 130% to 140%, from 130% to 135%, from 135% to 175%, from 135% to 170%, from 135% to 165%, from 135% to 160%, from 135% to 155%, from 135% to 150%, from 135% to 145%, from 135% to 140%, from 140% to 175%, from 140% to 170%, from 140% to 165%, from 140% to 160%, from 140% to 155%, from 140% to 150%, from 140% to 145%, from 145% to 175%, from 145% to 170%, from 145% to 165%, from 145% to 160%, from 145% to 155%, from 145% to 150%, from 150% to 175%, from 150% to 170%, from 150% to 165%, from 150% to 160%, from 150% to 155%, from 155% to 175%, from 155% to 170%, from 155% to 165%, from 155% to 160%, from 160% to 175%, from 160% to 170%, from 160% to 165%, from 165% to 175%, from 165% to 170%, or from 170% to 175%. Such a ratio may allow for good particulate solids follow into a vessel.

In other embodiments, one or both of the first solids director 240 and the second solids director 340 may be a pipe type distributor as disclosed in U.S. Pat. No. 9,360,759, incorporated by reference herein in its entirety.

In some embodiments, as shown in FIGS. 1 and 2, the particulate solids distributor 100 may comprise an inlet conduit 270. The inlet conduit 270 may be at least partially defined by an inlet conduit wall 274. The inlet conduit 270 may extend from an inlet conduit inlet 275 to an inlet conduit outlet 272. Generally, the inlet conduit 270 may be bound by the inlet conduit wall 274, which may be, for example, a pipe shaped member. The inlet conduit wall 274 may be arranged around a central inlet conduit axis. In one or more embodiments, the inlet conduit wall 274 may have a circular, oval, elliptical, or polygonal cross-sectional shape in a plane perpendicular to the central inlet conduit axis. In one or more embodiments, the refractory lining 370 may cover at least a portion of the inlet conduit wall 274. In some embodiments, not shown in FIGS. 1 and 2, the refractory lining 370 may not cover at least a portion of the inlet conduit wall 274.

Now referring to FIG. 1, in one or more embodiments, the inlet conduit 270 may intersect the outer wall 360. In one or more embodiments, the inlet conduit 270 may be positioned at the inner wall such that the inlet conduit 270 is in communication with the inner conduit 200. In such embodiments, the inlet conduit outlet 272 may be the inner conduit inlet 210. Generally, as described herein, the first particulate solids stream may pass through the inlet conduit 270 and into the inner conduit 200. In some embodiments, as depicted in FIG. 1, inlet conduit 270 may join the inner conduit 200 at an angle such that inlet conduit outlet 272 is pointed in a generally upstream direction of inner conduit 200. In other embodiments, inlet conduit 270 may join inner conduit 200 at an angle such that inlet conduit outlet 272 is pointed in a generally downstream direction of inner conduit 200 (not depicted in FIG. 1).

Referring now to FIG. 2, in one or more embodiments, the inlet conduit 270 may be positioned at the outer wall such that the inlet conduit 270 is in communication with the outer conduit. In such embodiments, the inner conduit outlet 272 may be the outer conduit inlet 310. Generally, as described herein, the second particulate solids stream may pass through the inlet conduit 270 and into the outer conduit 300. In such embodiments, the inlet conduit outlet 272 may be the outer conduit inlet 310. In some embodiments, as depicted in FIG. 2, inlet conduit 270 may join the outer conduit 300 at an angle such that inlet conduit outlet 272 is pointed in a generally upstream direction of outer conduit 300. In other embodiments, inlet conduit 270 may join outer conduit 300 at an angle such that inlet conduit outlet 272 is pointed in a generally downstream direction of outer conduit 300 (not depicted in FIG. 2).

Referring back to FIG. 1, in one or more embodiments the particulate solids distributor 100 may include a particulate solids guide 500. Generally, as described herein, the particulate solids guide 500 may equally direct the second particulate solids stream entering the outer conduit 300 through the outer conduit inlet 310 around the inner wall 260 and through the outer conduit 300. In one or more embodiments, the particulate solids guide 500 may be at least partially defined by the inner conduit wall 260. Generally, the particulate solids guide 500, in conjunction with the diameters of the inner and outer walls 260, 360 may be oriented such that the cross-sectional area of the outer conduit 300 is approximately equal or at least within a zone of tolerance across the height of the outer conduit 300. This aspect may maintain fluidization and superficial velocity of the solids throughout the height of the outer conduit 300, as would be understood by those skilled in the art.

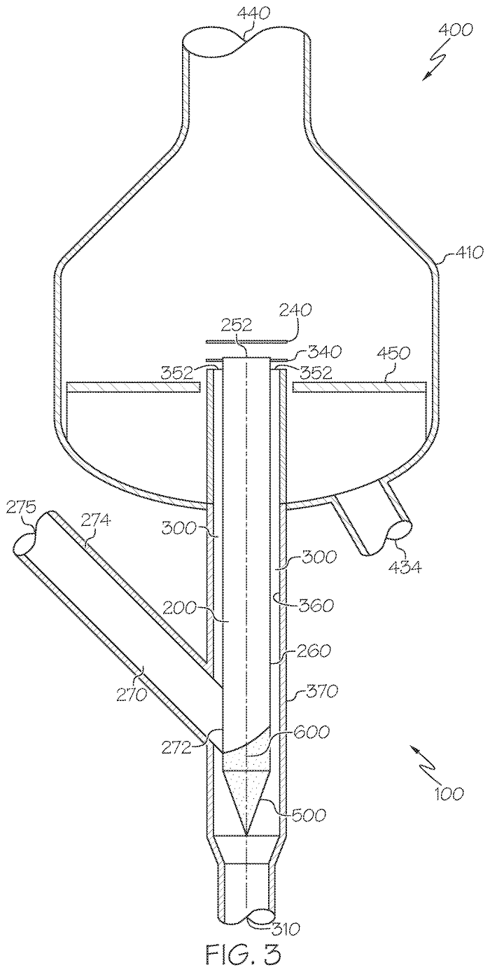

Now referring to FIG. 3 a chemical processing vessel 400 utilizing the particulate solids distributor 100 of FIG. 1 is schematically depicted. Though not depicted in FIG. 3 the particulate solids distributor 100 of FIG. 2 may also be utilized in chemical processing vessel 400. Chemical processing vessel 400 may include a vessel wall 410, a feed inlet 434, a feed distribution plate 450 and a processed chemical outlet 440. Feed inlet 434 may be at least partially defined by vessel wall 410. In one or more embodiments the particulate solids distributor 100 may extend into chemical processing vessel 400 such that the inner conduit outlet 252 may be downstream of the outer conduit outlet 352 relative to the feed inlet 434 (in the bottom of the vessel 400). In some embodiments, the particulate solids distributor 100 may extend into the chemical processing vessel through a bottom end of the chemical processing vessel 400 as depicted in FIG. 3.

In one or more embodiments, the chemical processing vessel 400 may include a feed distribution plate 450. The feed distribution plate 450 may evenly distribute feed from feed inlet 434 across the entire surface of the feed distribution plate 450. In embodiments, where the chemical processing vessel 400 includes a feed distribution plate 450 the particulate solids distributor 100 may be distinct from the feed distribution plate 450. For example, the outer wall 360 and feed distribution plate 450 may be spaced apart, such that particulate solids distributor 100 and the feed distribution plate 450 are not joined and/or connected. In some embodiments, where the chemical processing vessel 400 comprises a feed distribution plate 450 the outer conduit outlet 352 may be positioned between the inner conduit outlet 252 and the feed distribution plate 450. In some embodiments, where the chemical processing vessel 400 comprises a feed distribution plate 450 the feed distribution plate 450 may be in-between the inner conduit outlet 252 and the outer conduit outlet 352 (not depicted in FIG. 3). In one or more embodiments, the chemical processing vessel 400 may be suitable for use as a fast fluidized, turbulent, or bubbling bed reactor.

The operation of chemical processing vessel 400 including the particulate solids distributor 100 will now be described in the context of FIG. 3. The chemical processing vessel 400 may be operated by first passing a feed stream into the chemical processing vessel 400 through the feed inlet 434. In embodiments, where the chemical processing vessel comprises a feed distribution plate 450 the feed stream may then pass through the feed distribution plate. The feed stream travels generally upwards through the chemical processing vessel from the feed inlet 434 to the processed chemical outlet 440. A first particulate solids stream may pass through the inlet conduit 270 and into the inner conduit 200 through inlet conduit outlet 272 and a second particulate solids stream may be separately passed into the outer conduit 300 through outer conduit inlet 310. The two particulate solid streams may pass upward through the inner and outer conduits to the chemical processing vessel 400. The second particulate solids stream may exit the outer conduit 300 through outer conduit outlet 352. The second particulate solids stream may then contact the second solids director 340 and be directed out of the particulate solids distributor 100 and into the chemical processing vessel 400. The first particulate solids stream may exit the inner conduit 200 through inner conduit 252. The first particulate solids stream may then contact the first solids director 240 and be directed out of the particulate solids distributor 100 and into the chemical processing vessel 400. As shown in FIG. 3, feed traveling from feed inlet 434 towards processed chemical outlet 440 will contact the second particulate solids stream directed into the chemical processing vessel by the second solids director 340 before the first particulate solids stream directed into the chemical processing vessel by the first solids director 240 as the second particulate solids stream enters the chemical processing vessel below the first particulate solids stream.

In the chemical processing vessel 400 the feed stream and the two particulate solid streams may mix to form a mixed stream. The mixed stream may pass out of the chemical processing vessel 400 through processed chemical outlet 440.

In one or more embodiments, the particulate solid in the particulate solid streams may be capable of fluidization. In some embodiments, the particulate solid may exhibit properties known in the industry as “Geldart A” or “Geldart B” properties. Particles may be classified as “Group A” or “Group B” according to D. Geldart, Gas Fluidization Technology, John Wiley & Sons (New York, 1986), 34-37; and D. Geldart, “Types of Gas Fluidization,” Powder Technol. 7 (1973) 285-292, which are incorporated herein by reference in their entireties.

Group A is understood by those skilled in the art as representing an aeratable powder, having a bubble-free range of fluidization; a high bed expansion; a slow and linear deaeration rate; bubble properties that may include a predominance of splitting/recoalescing bubbles, with a maximum bubble size and large wake; high levels of solids mixing and gas backmixing, assuming equal U-Umf (U is the velocity of the carrier gas, and Umf is the minimum fluidization velocity, typically though not necessarily measured in meters per second, m/s, i.e., there is excess gas velocity); axisymmetric slug properties; and no spouting, except in very shallow beds. The properties listed tend to improve as the mean particle size decreases, assuming equal cfp; or as the <45 micrometers (μm) proportion is increased; or as pressure, temperature, viscosity, and density of the gas increase. In general, the particles may exhibit a small mean particle size and/or low particle density (<1.4 grams per cubic centimeter, g/cm³), fluidize easily, with smooth fluidization at low gas velocities, and may exhibit controlled bubbling with small bubbles at higher gas velocities.

Group B is understood by those skilled in the art as representing a “sand-like” powder that starts bubbling at Umf; that exhibits moderate bed expansion; a fast deaeration; no limits on bubble size; moderate levels of solids mixing and gas backmixing, assuming equal U-Umf; both axisymmetric and asymmetric slugs; and spouting in only shallow beds. These properties tend to improve as mean particle size decreases, but particle size distribution and, with some uncertainty, pressure, temperature, viscosity, or density of gas seem to do little to improve them. In general, most of the particles having a particle size (cfp) of 40 μm<cfp<500 μm when the density (pp) is 1.4<pp<4 g/cm³, and preferably 60 μm<cfp<500 μm when the density (pp) is 4 g/cm³ and 250 μm<cfp<100 μm when the density (pp) is 1 g/cm³.

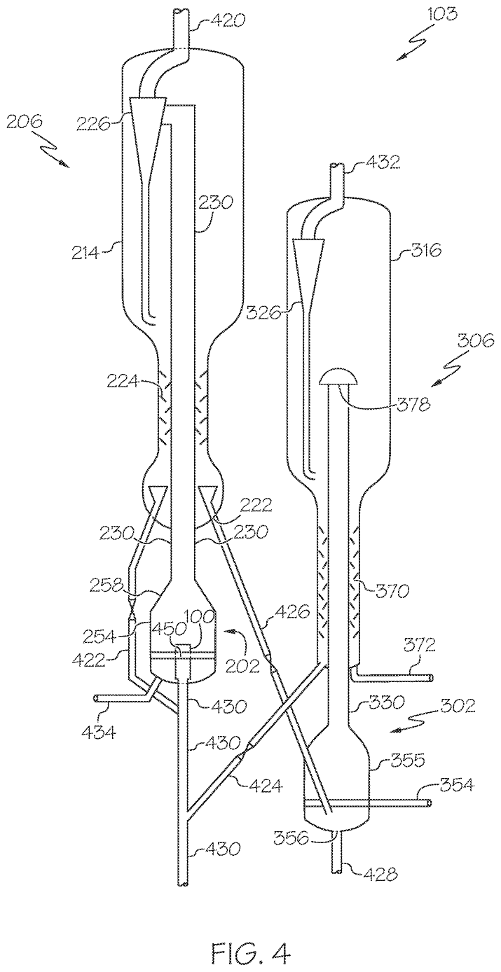

Embodiments presently disclosed will now be described in detail herein in the context of the reactor system 103 of FIG. 4. However, it should be understood that the principles disclosed and taught herein may be applicable to other systems which utilize different system components oriented in different ways, or different reaction schemes utilizing various catalyst compositions and chemical reactants. For example, the concepts described may be equally applied to other systems with alternate reactor units and regeneration units, such as those that operate under non-fluidized conditions or include downers rather than risers. It should be further understood that not all portions of the reactor system of FIG. 4 should be construed as essential to the claimed subject matter.

Now referring to FIG. 4, an example reactor system 103 that may be suitable for use with the methods and/or apparatuses described herein is schematically depicted. The reactor system 103 generally comprises multiple system components, such as a reactor portion 206 and a regeneration unit 306. As described herein, “system components” refer to portions of the reactor system 103, such as reactors, separators, transfer lines, combinations thereof, and the like. As used herein in the context of FIG. 4, the reactor portion 206 generally refers to the portion of a reactor system 103 in which the major process reaction takes place (e.g., dehydrogenation) to form the product stream. The reactor portion 206 comprises a reactor 202, which may include an upstream reactor section 254 and a downstream reactor section 230. Reactor 202 of FIG. 4 may correspond to chemical processing vessel 400 of FIG. 4 and include particulate solids distributor 100. According to one or more embodiments, as depicted in FIG. 4 the reactor portion 206 may additionally include a particulate solids separation section 214, which serves to separate the catalyst from the chemical products formed in the reactor 202. Also as used herein, the regeneration unit 306 generally refers to the portion of the reactor system 103 where the particulate solid is processed in some way. As used herein, the regeneration unit 306 generally refers to the portion of the reactor system 103 where the particulate solid is in some way processed, such as by combustion, to, e.g., improve catalytic activity and/or heat the particulate solid. The regeneration unit 306 may comprise a combustor 355 and a riser 330, a particulate solid separation section 316, and may additionally comprise an oxygen treatment zone 370. In one or more embodiments, the particulate solid separation section 214 may be in fluid communication with the combustor 355 (e.g., via standpipe 426) and the particulate solid separation section 316 may be in fluid communication with the upstream reactor section 254 (e.g., via standpipe 424 and transport riser 430). In one or more embodiments the chemical processing vessel 400 may correspond to the combustor 355. Though not shown in FIG. 4, it is contemplated that the particulate solids distributor 100 may be utilized in the combustor 355 to distribute particulate solid.

Generally, as is described herein, in embodiments illustrated in FIG. 4 a portion of the particulate solid is cycled between the reactor portion 206 and the regeneration unit 306. It should be understood that when particulate solids are referred to herein, they may refer to solid materials that are catalytically active for a desired reaction, or may equally refer to other particulate solids referenced with respect to the system of FIG. 4 which do not necessarily have catalytic activity but affect the reaction, such as oxygen-carrier materials. The terms “catalytic activity” and “catalyst activity” refer to the degree to which a catalyst is able to catalyze the reactions conducted in the reactor system 103. The particulate solid that exits the reactor portion 206 may be deactivated catalyst. As used herein, “deactivated” may refer to a catalyst, which has reduced catalytic activity or is cooler as compared to catalyst entering the reactor portion 206. However, deactivated catalyst may maintain some catalytic activity. Reduced catalytic activity may result from contamination with a substance such as coke. Reactivation (sometimes called “regeneration” herein) may remove the contaminant such as coke, raise the temperature of the catalyst, or both. In embodiments, deactivated catalyst may be reactivated by catalyst reactivation in the regeneration unit 306. The deactivated catalyst may be reactivated by, but not limited to, removing coke by combustion, recovering catalyst acidity, oxidizing the catalyst, other reactivation process, or combinations thereof. In some embodiments, the catalyst may be heated during reactivation by combustion of a fuel, such as hydrogen, methane, ethane, propane, natural gas, or combinations thereof. The regenerated catalyst from the regeneration unit 306 may then be passed back to the reactor portion 206.

As described with respect to FIG. 4, the feed stream may enter feed inlet 434 into the reactor 202, and the product stream may exit the reactor system 103 via pipe 420. According to one or more embodiments, the reactor system 103 may be operated by feeding a chemical feed (e.g., in a feed stream) and a fluidized particulate solid into the upstream reactor section 254. The fluidized particulate solid may be fed into the upstream reactor section 254 by the particulate solids distributor 100. The chemical feed contacts the particulate solid in the upstream reactor section 254, and each flow upwardly into and through the downstream reactor section 230 to produce a chemical product.

Now referring to FIG. 4 in detail, the reactor portion 206 may comprise an upstream reactor section 254, a transition section 258, and a downstream reactor section 230, such as a riser. The transition section 258 may connect the upstream reactor section 254 with the downstream reactor section 230. As depicted in FIG. 4, the upstream reactor section 254 may be positioned below the downstream reactor section 230. Such a configuration may be referred to as an upflow configuration in the reactor 202. The upstream reactor section 254 may include a vessel, drum, barrel, vat, or other container suitable for a given chemical reaction. As depicted in FIG. 4, the upstream reactor section 254 may be connected to the downstream reactor section 230 via the transition section 258. The upstream reactor section 254 may generally comprise a greater cross-sectional area than the downstream reactor section 230. The transition section 258 may be tapered from the size of the cross-section of the upstream reactor section 254 to the size of the cross-section of the downstream reactor section 230 such that the transition section 258 projects inwardly from the upstream reactor section 254 to the downstream reactor section 230. For example, the transition section 258 may be a frustum.

The upstream reactor section 254 may be connected to a transport riser 430, which, in operation may provide regenerated particulate solid in a feed stream to the reactor portion 206. The particulate solid may enter the reactor 202 through the particulate solids distributor 100. The particulate solid entering the upstream reactor section 254 via transport riser 430 may be passed through standpipe 424 to a transport riser 430, thus arriving from the regeneration unit 306. A portion of particulate solid may come directly from the particulate solid separation section 214 via standpipe 422 and into the transport riser 430, where it enters the upstream reactor section 254. This particulate solid may be somewhat deactivated, but may still, in some embodiments, be suitable for reaction in the upstream reactor section 254, particularly when used in combination with the regenerated particulate solid. The regenerated particulate solid arriving from the regeneration unit 306 and the portion of deactivated particulate solid arriving from particulate solid separation section 214 via standpipe 422 may be kept separate within the transport riser 430 before being passed separately into the reactor 202 via particulate solids distributor 100.

Still referring to FIG. 4, in one or more embodiments, based on the shape, size, and other processing conditions (such as temperature and pressure) in the upstream reactor section 254 and the downstream reactor section 230, the upstream reactor section 254 may operate as a fluidized bed, such as in a fast fluidized, turbulent, or bubbling bed upflow reactor, while the downstream reactor section 230 may operate in more of a plug flow manner, such as in a riser reactor. For example, the reactor 202 of FIG. 4 may comprise an upstream reactor section 254 operating as a fast fluidized, turbulent, or bubbling bed reactor and a downstream reactor section 230 operating as a dilute phase riser reactor, with the result that the average particulate solid and gas flow moves concurrently upward. As the term is used herein, “average flow” refers to the net flow, i.e., the total upward flow minus the retrograde or reverse flow, as is typical of the behavior of fluidized particles in general. As described herein, a “fast fluidized” reactor may refer to a reactor utilizing a fluidization regime wherein the superficial velocity of the gas phase is greater than the choking velocity and may be semi-dense in operation. As described herein, a “turbulent” reactor may refer to a fluidization regime where the superficial velocity of less than the choking velocity and is denser than the fast fluidized regime. As described herein, a “bubbling bed” reactor may refer to a fluidization regime wherein well defined bubbles in a highly dense bed are present in two distinct phases. The “choking velocity” refers to the minimum velocity required to maintain solids in the dilute-phase mode in a vertical conveying line. As described herein, a “dilute phase riser” may refer to a riser reactor operating at transport velocity, where the gas and particulate solid have about the same velocity in a dilute phase.

According to embodiments, the chemical product and the particulate solid may be passed out of the downstream reactor section 230 to a separation device 226 in the particulate solid separation section 214, where the particulate solid is separated from the chemical product, which is transported out of the particulate solid separation section 214. According to one or more embodiments, following separation from vapors in the separation device 226, the particulate solid may generally move through the strip zone 224 to the particulate solid outlet port 222 where the particulate solid is transferred out of the reactor portion 206 via standpipe 426 and into the regeneration unit 306.

Referring still to FIG. 4, according to one or more embodiments, the separation device 226 may be a cyclonic separation system, which may include two or more stages of cyclonic separation. In embodiments where the separation device 226 comprises more than one cyclonic separation stages, the first separation device into which the fluidized stream enters is referred to a primary cyclonic separation device. The fluidized effluent from the primary cyclonic separation device may enter into a secondary cyclonic separation device for further separation. Primary cyclonic separation devices may include, for example, primary cyclones, and systems commercially available under the names VSS (commercially available from UOP), LD2 (commercially available from Stone and Webster), and RS2 (commercially available from Stone and Webster). Primary cyclones are described, for example, in U.S. Pat. Nos. 4,579,716; 5,190,650; and 5,275,641, which are each incorporated by reference in their entirety herein. In some separation systems utilizing primary cyclones as the primary cyclonic separation device, one or more set of additional cyclones, e.g. secondary cyclones and tertiary cyclones, are employed for further separation of the particulate solid from the product gas. It should be understood that any primary cyclonic separation device may be used in embodiments of the invention.

Still referring to FIG. 4, the separated particulate solid is passed from the particulate solid separation section 214 to the combustor 355. In the combustor 355, the particulate solid may be processed by, for example, combustion with oxygen. For example, and without limitation, the particulate solid may be de-coked and/or fuel may be combusted to heat the particulate solid. In one or more embodiments the particulate solid 100 may be passed into the combustor through the particulate solids distributor 100 (not shown in FIG. 4). The particulate solid is then passed out of the combustor 355 and through the riser 330 to a riser termination separator 378, where the gas and solid components from the riser 330 are at least partially separated. The vapor and remaining solids are transported to a secondary separation device 326 in the particulate solid separation section 316 where the remaining particulate solid is separated from the gases from the particulate solid processing (e.g., gases emitted by combustion of spent particulate solid or fuel, referred to herein as flue gas). The flue gas may pass out of the regeneration unit 306 via outlet pipe 432. The separated particulate solid is then passed through the oxygen treatment zone 370 within the particulate solid separation section 316 to the upstream reactor section 254 via standpipe 424 and transport riser 430, where it is further utilized in a catalytic reaction. Thus, the particulate solid, in operation, may cycle between the reactor portion 206 and the regeneration unit 306. In general, the processed chemical streams, including the feed streams and product streams may be gaseous, and the particulate solid may be fluidized particulate solid.

Referring now to the regeneration unit 306, as depicted in FIG. 4, the combustor 355 of the regeneration unit 306 may include one or more lower reactor portion inlet ports 356 and may be in fluid communication with the riser 330. Oxygen-containing gas, such as air, may be passed through pipe 428 into the combustor 355. The combustor 355 may be in fluid communication with the particulate solid separation section 214 via standpipe 426, which may supply spent particulate solid from the reactor portion 206 to the regeneration unit 306 for regeneration. The combustor 355 and riser 330, collectively referred to as the particulate solid combustion reactor 302, may operate with similar or identical fluidization regimes as to what was disclosed with respect to the upstream reactor section 254 and downstream reactor section 230 of the reactor portion 206. That is, the combustor 355 may operate as a fluidized bed, such as in a fast fluidized, turbulent, or bubbling bed upflow reactor, while the riser 330 may operate in more of a plug flow manner, such as in a riser reactor. Geometries as described with respect to the upstream reactor section 254 and downstream reactor section 230 may equally apply to the combustor 355 and riser 330. Additionally, the combustor 355 may also include a fuel inlet 354, which may supply a fuel, such as a hydrocarbon stream or hydrogen, to the combustor 355. In one or more embodiments, the combustor 355 may be the chemical processing vessel 400 of FIG. 3.

As described in one or more embodiments, following separation of flue gas from particulate solid in the riser termination separator 378 and secondary separation device 326, treatment of the processed particulate solid with an oxygen-containing gas is conducted in the oxygen treatment zone 370. In some embodiments, the oxygen treatment zone 370 includes a fluid solids contacting device. The fluid solids contacting device may include baffles or grid structures to facilitate contact of the processed particulate solid with the oxygen-containing gas. Examples of fluid solid contacting devices are described in further detail in U.S. Pat. Nos. 9,827,543 and 9,815,040. The fluidization regime within the oxygen treatment zone 370 may be bubbling bed type fluidization. The oxygen treatment zone 370 may include an oxygen-containing gas inlet 372, which may supply an oxygen-containing gas to the oxygen treatment zone 370 for oxygen treatment of the particulate solid.

Now, referring back to FIG. 3, in non-limiting examples, the chemical processing vessel 400 described herein may be utilized to produce olefinic compounds from hydrocarbon feed streams. As used herein, the term “olefinic compounds” refers to hydrocarbons having one or more carbon-carbon double bonds apart from the formal double bonds in aromatic compounds. For example, ethylene and styrene are olefinic compounds, but ethylbenzene would not be an olefinic compound as the only double bonds present in ethylbenzene are formal double bonds present as part of the aromatic structure. Olefinic compounds may be produced from a variety of hydrocarbon feed streams by utilizing different reaction mechanisms. For example, olefinic compounds may be produced by at least dehydrogenation reactions, cracking reactions, dehydration reactions, and methanol-to-olefin reactions. These reaction types may utilize different feed streams and different fluidized particulates to produce olefinic compounds. It is contemplated that the particulate solids distributor 100 and the chemical processing vessel 400 of FIG. 3 may be utilized to perform reactions in reactor systems other than those described in the context of the reactor system 103 of FIG. 4.

According to one or more embodiments, the reaction may be a dehydrogenation reaction. According to such embodiments, the one or more hydrocarbons may be a hydrocarbon feed stream the hydrocarbon feed stream may comprise one or more of ethylbenzene, ethane, propane, n-butane, and i-butane. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethylbenzene. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of ethylbenzene, ethane, propane, n-butane, and i-butane.

In one or more embodiments, the dehydrogenation reaction may utilize gallium and/or platinum fluidized particulates as a catalyst. In such embodiments, the fluidized particulates may comprise a gallium and/or platinum catalyst. As described herein, a gallium and/or platinum catalyst comprises gallium, platinum, or both. The gallium and/or platinum catalyst may be carried by an alumina or alumina silica support, and may optionally comprise potassium. Such gallium and/or platinum catalysts are disclosed in U.S. Pat. No. 8,669,406, which is incorporated herein by reference in its entirety. However, it should be understood that other suitable catalysts may be utilized to perform the dehydrogenation reaction.

In one or more embodiments, the reaction mechanism may be dehydrogenation followed by combustion (in the same chamber). In such embodiments, a dehydrogenation reaction may produce hydrogen as a byproduct, and an oxygen carrier material may contact the hydrogen and promote combustion of the hydrogen, forming water. Examples of such reaction mechanisms, which are contemplated as possible reactions mechanisms for the systems and methods described herein, are disclosed in WO 2020/046978 and U.S. Pat. Pub. No. 2021/0292259 the teachings of which are incorporated by reference in their entireties herein.

In one or more embodiments, the fluidized particulate may comprise an oxygen-carrier material and a dehydrogenation catalyst material. In some embodiments, the fluidized particulate may consist essentially of the oxygen-carrier material. As described herein, “consists essentially of” refers to materials with less than 1 wt. % of the non-recited materials (i.e., consisting essentially of A means A is at least 99 wt. % of the composition). In some embodiments, the fluidized particulate may not comprise a dehydrogenation catalyst material. In some embodiments, the oxygen-carrier material and the dehydrogenation catalyst material may be separate particles of the fluidized particulate. In some embodiments, the oxygen-carrier material and the dehydrogenation catalyst may be contained in the same particles of the fluidized particulate.

In embodiments where the fluidized particulate comprises a dehydrogenation catalyst, the dehydrogenation of the one or more hydrocarbons may be at least partially by catalytic dehydrogenation. Catalytic dehydrogenation is the dehydrogenation of a hydrocarbon that is promoted by the use of a dehydrogenation catalyst. In embodiments, where the fluidized particulate does not comprise a dehydrogenation catalyst the dehydrogenation reaction may be a non-catalytic thermal dehydrogenation reaction. Non-catalytic thermal dehydrogenation refers to the dehydrogenation of a hydrocarbon that occurs without the use of a dehydrogenation catalyst and instead may occur because of high temperature.

In some embodiments, the fluidized particulate may comprise a “dual-purpose material” that may act as both a dehydrogenation catalyst as well as an oxygen-carrier material. It should be understood that, in at least the embodiments described herein where an oxygen-carrier material and a dehydrogenation catalyst are utilized in the same reaction vessel (such as those of FIG. 1), such a dual-purpose material may be utilized either in replacement or in combination with the oxygen-carrier material of the fluidized particulate or the dehydrogenation catalyst of the fluidized particulate.

According to one or more embodiments, the reaction may be a cracking reaction. According to such embodiments, the hydrocarbon feed stream may comprise one or more of naphtha, n-butane, or i-butane. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of naphtha. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of naphtha, n-butane, and i-butane.

In one or more embodiments, the cracking reaction may utilize one or more zeolites as a catalyst. In such embodiments, the fluidized particulates may comprise one or more zeolites. In some embodiments, the one or more zeolites utilized in the cracking reaction may comprise a ZSM-5 zeolite. However, it should be understood that other suitable catalysts may be utilized to perform the cracking reaction. For example, suitable catalysts that are commercially available may include Intercat Super Z Excel or Intercat Super Z Exceed. In additional embodiments, the cracking catalyst may comprise, in addition to a catalytically active material, platinum. For example, the cracking catalyst may include from 0.001 wt. % to 0.05 wt. % of platinum. The platinum may be sprayed on as platinum nitrate and calcined at an elevated temperature, such as around 200° C. to 800° C. Without being bound by theory, it is believed that the addition of platinum to the catalyst may allow for easier combustion of fuels, such as methane.

According to one or more embodiments, the reaction may be a dehydration reaction. According to such embodiments, the hydrocarbon feed stream may comprise one or more of ethanol, propanol, or butanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of butanol. In additional embodiments, the hydrocarbon feed stream or may comprise at least 50 wt. %, at least 60 wt. %, at least 70 wt. %, at least 80 wt. %, at least 90 wt. %, at least 95 wt. % or even at least 99 wt. % of the sum of ethanol, propanol, and butanol.

In one or more embodiments, the dehydration reaction may utilize one or more acid catalysts. In such embodiments, the fluidized particulates may comprise one or more acid catalysts. In some embodiments, the one or more acid catalysts utilized in the dehydration reaction may comprise a zeolite (such as ZSM-5 zeolite), alumina, amorphous aluminosilicate, acid clay, or combinations thereof. For example, commercially available alumina catalysts which may be suitable, according to one or more embodiments, include SynDol (available from Scientific Design Company), V200 (available from UOP), or P200 (available from Sasol). Commercially available zeolite catalysts which may be suitable include CBV 8014, CBV 28014 (each available from Zeolyst). Commercially available amorphous aluminosilicate catalysts which may be suitable include silica-alumina catalyst support, grade 135 (available from Sigma Aldrich). However, it should be understood that other suitable catalysts may be utilized to perform the dehydration reaction.

According to one or more embodiments, the reaction may be a methanol-to-olefin reaction. According to such embodiments, the hydrocarbon feed stream may comprise methanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of methanol.

In one or more embodiments, the methanol-to-olefin reaction may utilize one or more zeolites as a catalyst. In such embodiments, the fluidized particulates may comprise one or more zeolites. In some embodiments, the one or more zeolites utilized in the methanol-to-olefin reaction may comprise a one or more of a ZSM-5 zeolite or a SAPO-34 zeolite. However, it should be understood that other suitable catalysts may be utilized to perform the methanol-to-olefin reaction.

In one or more embodiments, the olefinic compounds may be present in a “product stream” sometimes called an “olefin-containing effluent”. Such a stream exits the reactor system of FIG. 4 and may be subsequently processed. In one or more embodiments, the olefinic compounds may comprise one or more of ethylene, propylene, butylene, or styrene. The term butylene includes any isomers of butylene, such as a-butylene, cis-ß-butylene, trans-ß-butylene, and isobutylene. In some embodiments, the olefin-containing effluent may comprise at least 20 wt. %, at least 30 wt. %, at least 40 wt. %, at least 50 wt. %, or even at least 60 wt. % of ethylene. In additional embodiments, the olefin-containing effluent may comprise at least 20 wt. %, at least 30 wt. %, at least 40 wt. %, at least 50 wt. %, or even at least 60 wt. % of propylene. In additional embodiments, the olefin-containing effluent may comprise at least 20 wt. %, at least 30 wt. %, at least 40 wt. %, at least 50 wt. %, or even at least 60 wt. % of butylene. In additional embodiments, the olefin-containing effluent may comprise at least 20 wt. %, at least 30 wt. %, at least 40 wt. %, at least 50 wt. %, or even at least 60 wt. % of styrene. In additional embodiments, the olefin-containing effluent may comprise at least 20 wt. %, at least 30 wt. %, at least 40 wt. %, at least 50 wt. %, or even at least 60 wt. % of the sum of one or more of ethylene, propylene, butylene, and styrene. The olefin-containing effluent may further comprise unreacted components of the feed stream, as well as other reaction products that are not considered light olefins. The olefinic compounds may be separated from unreacted components in subsequent separation steps.

In a first aspect of the present disclosure a particulate solids distributor suitable for distributing two particulate solid streams may comprise an inner conduit extending from an inner conduit inlet to an inner conduit outlet. The inner conduit may be defined at least partially by an inner wall and the inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis and a cross-section of the outer wall may surround a cross-section of the inner wall in a plane perpendicular to the central axis. The particulate solids distributor may also comprise a first solids director positioned over the central axis and downstream of the inner conduit outlet. The particulate solids distributor may also comprise a second solids director attached to the inner wall and extending radially outward from the central axis. The inner conduit may extend past the outer conduit such that the inner conduit outlet may be downstream of the outer conduit outlet.

A second aspect of the present disclosure includes any previous aspect or combination of aspects, where the first solids director is a first deflector plate and the second solids director is a second deflector plate.

A third aspect of the present disclosure includes any previous aspect or combination of aspects, where the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

A fourth aspect of the present disclosure includes any previous aspect or combination of aspects, where the inner wall has a circular cross-sectional shape in a plane perpendicular to the central axis, and the outer wall has a circular cross-sectional shape in a plane perpendicular to the central axis.

A fifth aspect of the present disclosure includes any previous aspect or combination of aspects, where the inner conduit outlet is downstream of the second solids director.

In a sixth aspect of the present disclosure a particulate solids distributor suitable for distributing two particulate solid streams may comprise an inner conduit extending from an inner conduit inlet to an inner conduit outlet. The inner conduit may be defined at least partially by an inner wall, and the inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis. A cross-section of the outer wall may surround a cross-section of the inner wall in a plane perpendicular to the central axis. The particulate solids distributor may also comprise an inlet conduit defined at least partially by an inlet conduit wall. The inlet conduit may extend from an inlet conduit inlet to an inlet conduit outlet. The inlet conduit may intersect the outer wall. The inlet conduit outlet may be positioned at the inner wall such that the inlet conduit may be in communication with the inner conduit. The particulate solids distributor may also comprise a first solids director positioned over the central axis and downstream of the inner conduit outlet. The particulate solids distributor may also comprise a second solids director attached to the inner wall and extending radially outward from the central axis. The inner conduit may extend past the outer conduit such that the inner conduit outlet may be downstream of the outer conduit outlet.

A seventh aspect of the present disclosure includes the sixth aspect, where the first solids director is a first deflector plate and the second solids director is a second deflector plate.

An eight aspect of the present disclosure includes the sixth or seventh aspects either alone or in any combination, where the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

A ninth aspect of the present disclosure includes the sixth to eight aspects either alone or in any combination, where the inner wall has a circular cross-sectional shape in a plane perpendicular to the central axis, and the outer wall has a circular cross-sectional shape in a plane perpendicular to the central axis.

A tenth aspect of the present disclosure includes the sixth to ninth aspects either alone or in any combination, where the inner conduit outlet is downstream of the second solids director.

In an eleventh aspect of the present disclosure a particulate solids distributor for distributing two particulate solids streams may comprise an inner conduit extending from an inner conduit inlet to an inner conduit outlet. The inner conduit may be defined at least partially by an inner wall. The inner wall may be arranged around a central axis. The particulate solids distributor may also comprise an outer conduit defined at least partially by the inner wall and an outer wall. The outer conduit may extend from an outer conduit inlet to an outer conduit outlet. The outer wall may be arranged around the central axis. A cross-section of the outer wall may surround a cross-section of the inner wall in a plane perpendicular to the central axis. The particulate solids distributor may also comprise an inlet conduit defined at least partially by an inlet conduit wall. The inlet conduit may extend from an inlet conduit inlet to an inlet conduit outlet. The inlet conduit outlet may be positioned at the outer wall such that the inlet conduit may be in communication with the outer conduit. The particulate solids distributor may also comprise a first solids director positioned over the central axis and downstream of the inner conduit outlet. The particulate solids director may also comprise a second solids director attached to the inner wall and extending radially outward from the central axis. The inner conduit may extend past the outer conduit such that the inner conduit outlet may be downstream of the outer conduit outlet.

A twelfth aspect of the present disclosure includes the eleventh aspect, where the first solids director is a first deflector plate and the second solids director is a second deflector plate.

A thirteenth aspect of the present disclosure includes the eleventh or twelfth aspects either alone or in any combination, where the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

A fourteenth aspect of the present disclosure includes the eleventh to thirteenth aspects either alone or in any combination, where the inner wall has a circular cross-sectional shape in a plane perpendicular to the central axis, and the outer wall has a circular cross-sectional shape in a plane perpendicular to the central axis.

A fifteenth aspect of the present disclosure includes the eleventh to fourteenth aspects either alone or in any combination, where the inner conduit outlet is downstream of the second solids director.

It will be apparent to those skilled in the art that various modifications and variations can be made to the presently disclosed technology without departing from the spirit and scope of the technology. Since modifications combinations, sub-combinations and variations of the disclosed embodiments incorporating the spirit and substance of the presently disclosed technology may occur to persons skilled in the art, the technology should be construed to include everything within the scope of the appended claims and their equivalents. Additionally, although some aspects of the present disclosure may be identified herein as preferred or particularly advantageous, it is contemplated that the present disclosure is not limited to these aspects.

It is noted that the various details described in this disclosure should not be taken to imply that these details relate to elements that are essential components of the various embodiments described in this disclosure, even in cases where a particular element is illustrated in each of the drawings that accompany the present description. Unless specifically identified as such, no feature disclosed and described herein should be construed as “essential”. Contemplated embodiments of the present technology include those that include some or all of the features of the appended claims.

It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

It is noted that one or more of the following claims and the detailed description utilize the terms “where” or “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. Where multiple ranges for a quantitative value are provided, these ranges may be combined to form a broader range, which is contemplated in the embodiments described herein.

As would be understood in the context of the term as used herein, the term “passing” may include directly passing a substance between two portions of the disclosed system and, in some other instances, to mean indirectly passing a substance between two portions of the disclosed system. For example, indirect passing may include steps where the named substance passes through an intermediate operations unit, valve, sensor, etc.

1. A particulate solids distributor suitable for distributing two particulate solid streams, the particulate solids distributor comprising:
an inner conduit extending from an inner conduit inlet to an inner conduit outlet, wherein the inner conduit is defined at least partially by an inner wall, and wherein the inner wall is arranged around a central axis;
an outer conduit defined at least partially by the inner wall and an outer wall, wherein the outer conduit extends from an outer conduit inlet to an outer conduit outlet, wherein the outer wall is arranged around the central axis, and wherein a cross-section of the outer wall surrounds a cross-section of the inner wall in a plane perpendicular to the central axis;
a first solids director positioned over the central axis and downstream of the inner conduit outlet; and
a second solids director attached to the inner wall and extending radially outward from the central axis; and
wherein:
the inner conduit extends past the outer conduit such that the inner conduit outlet is downstream of the outer conduit outlet.

2. The particulate solids distributor of claim 1, wherein the first solids director is a first deflector plate and the second solids director is a second deflector plate.

3. The particulate solids distributor of claim 1, wherein the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

4. The particulate solids distributor of claim 1, wherein the inner wall has a circular cross-sectional shape in a plane perpendicular to the central axis, and the outer wall has a circular cross-sectional shape in a plane perpendicular to the central axis.

5. The particulate solids distributor of claim 1, wherein the inner wall extends past an end point of the outer wall at the outer conduit outlet.

6. A particulate solids distributor suitable for distributing two particulate solid streams, the particulate solids distributor comprising:
an inner conduit extending from an inner conduit inlet to an inner conduit outlet, wherein the inner conduit is defined at least partially by an inner wall, and wherein the inner wall is arranged around a central axis;
an outer conduit defined at least partially by the inner wall and an outer wall, wherein the outer conduit extends from an outer conduit inlet to an outer conduit outlet, wherein the outer wall is arranged around the central axis, and wherein a cross-section of the outer wall surrounds a cross-section of the inner wall in a plane perpendicular to the central axis;
an inlet conduit defined at least partially by an inlet conduit wall, wherein the inlet conduit extends from an inlet conduit inlet to an inlet conduit outlet, wherein the inlet conduit intersects the outer wall, and wherein the inlet conduit outlet is positioned at the inner wall such that the inlet conduit is in communication with the inner conduit;
a first solids director positioned over the central axis and downstream of the inner conduit outlet; and
a second solids director attached to the inner wall and extending radially outward from the central axis; and
wherein the inner conduit extends past the outer conduit such that the inner conduit outlet is downstream of the outer conduit outlet.

7. The particulate solids distributor of claim 6, wherein the first solids director is a first deflector plate and the second solids director is a second deflector plate.

8. The particulate solids distributor of claim 6, wherein the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

9. The particulate solids distributor of claim 6, wherein the inner wall has a circular cross-sectional shape in a plane perpendicular to the central axis, and the outer wall has a circular cross-sectional shape in a plane perpendicular to the central axis.

10. The particulate solids distributor claims 6, wherein the inner conduit outlet is downstream of the second solids director.

11. A particulate solids distributor suitable for distributing two particulate solid streams, the particulate solids distributor comprising:
a inner conduit extending from an inner conduit inlet to an inner conduit outlet, wherein the inner conduit is defined at least partially by an inner wall, and wherein the inner wall is arranged around a central axis;
a outer conduit defined at least partially by the inner wall and an outer wall, wherein the outer conduit extends from an outer conduit inlet to an outer conduit outlet, wherein the outer wall is arranged around the central axis, and wherein a cross-section of the outer wall surrounds a cross-section of the inner wall in a plane perpendicular to the central axis;
an inlet conduit defined at least partially by an inlet conduit wall, wherein the inlet conduit extends from an inlet conduit inlet to an inlet conduit outlet, and wherein the inlet conduit outlet is positioned at the outer wall such that the inlet conduit is in communication with the outer conduit;
a first solids director positioned over the central axis and downstream of the inner conduit outlet; and
a second solids director attached to the inner wall and extending radially outward from the central axis; and
wherein the inner conduit extends past the outer conduit such that the inner conduit outlet is downstream of the outer conduit outlet.

12. The particulate solids distributor of claim 11, wherein the first solids director is a first deflector plate and the second solids director is a second deflector plate.

13. The particulate solids distributor of claim 11, wherein the inner wall has a circular, oval, elliptical, or polygonal cross-sectional shape in a plane perpendicular to the central axis, and the outer wall has a circular, oval, elliptical, or polygonal cross-sectional shape in a plane perpendicular to the central axis.

14. The particulate solids distributor of claim 11, wherein the inner wall has a circular cross-sectional shape in a plane perpendicular to the central axis, and the outer wall has a circular cross-sectional shape in a plane perpendicular to the central axis.

15. The particulate solids distributor of claim 11, wherein the inner conduit outlet is downstream of the second solids director.
